(19) United States
(12) Patent Application Publication
(10) Pub. No.: US 2026/0066194 A1
(43) Pub. Date: Mar. 5, 2026

(54) METHOD OF MANUFACTURING MULTILAYER ELECTRONIC COMPONENT

(71) Applicant: SAMSUNG ELECTRO-MECHANICS CO., LTD., Suwon-si (KR)

(72) Inventors: Young Rae CHO, Suwon-si (KR); Jin Ho CHOI, Suwon-si (KR); Jong Ho LEE, Suwon-si (KR); Eun Jung LEE, Suwon-si (KR); Yong Min HONG, Suwon-si (KR)

(73) Assignee: SAMSUNG ELECTRO-MECHANICS CO., LTD., Suwon-si (KR)

(21) Appl. No.: 19/068,622

(22) Filed: Mar. 3, 2025

(30) Foreign Application Priority Data
Aug. 29, 2024 (KR) 10-2024-0116489

(51) Int. Cl. H01G 13/00; C04B 35/64; H01G 4/012; H01G 4/224; H01G 4/30

(52) U.S. Cl. CPC H01G 13/00; C04B 35/64; H01G 4/012; H01G 4/224; H01G 4/30

(57) ABSTRACT

A method for manufacturing a multilayer electronic component, includes forming a stack chip including a side margin attachment surface, connected to a first internal electrode pattern and a second internal electrode pattern, by alternately disposing a dielectric ceramic sheet, the first internal electrode pattern, and the second internal electrode pattern; forming a side margin portion on the side margin attachment surface; forming a body by sintering the stack chip on which the side margin portion is formed; and forming an external electrode on the body. The forming the side margin portion is performed by disposing a side margin sheet on the side margin attachment surface, and applying pressure thereto with a roller.

### CROSS-REFERENCE TO RELATED APPLICATION(S)

This application claims benefit of priority to Korean Patent Application No. 10-2024-0116489 filed on Aug. 29, 2024 in the Korean Intellectual Property Office, the disclosure of which is incorporated herein by reference in its entirety.

### TECHNICAL FIELD

The present disclosure relates to a method for manufacturing a multilayer electronic component.

A multilayer ceramic capacitor (MLCC), a multilayer electronic component, may be a chip condenser mounted on the printed circuit boards of various types of electronic products, such as image display devices including a liquid crystal display (LCD), a plasma display panel (PDP), or the like, a computer, a smartphone, a mobile phone, an infotainment system, or the like, and serving to charge or discharge electricity therein or therefrom.

A side margin portion of the multilayer electronic component may play a role in preventing damage to an internal electrode due to physical or chemical stress. Meanwhile, in order to suppress a step difference caused by the internal electrode, a method in which an internal electrode is cut to be exposed from both end surfaces of a stack chip after stacking, and then a single dielectric layer or two or more dielectric layers (side margin sheets) are stacked on both side surfaces of a capacitance formation portion to form a margin portion has been used.

However, during a high-temperature pressing process and a punching process, performed to attach a side margin sheet to a stack chip, spatial distribution may increase due to causes such as uneven thermal expansion of a mold, or the like, and accordingly, bonding force between the stack chip and the side margin sheet may decrease, which may lower moisture resistance reliability of the multilayer electronic component.

Therefore, there is a need for improvement in a method of forming a side margin portion to improve adhesion between a side margin sheet and a stack chip.

### SUMMARY

An aspect of the present disclosure is to alleviate a problem of moisture resistance reliability of a multilayer electronic component lowered due to a decrease in adhesion of a side margin portion in the multilayer electronic component including the side margin portion.

An aspect of the present disclosure is to alleviate a problem of size dispersion of a multilayer electronic component increasing due to pressure applied during formation of a side margin portion in the multilayer electronic component including the side margin portion.

However, the purpose of the present disclosure is not limited to the above-described contents, and will be more easily understood in the process of illustrating specific embodiments of the present disclosure.

According to an aspect of the present disclosure, a method for manufacturing a multilayer electronic component, includes forming a stack chip including a side margin attachment surface, connected to a first internal electrode pattern and a second internal electrode pattern, by alternately disposing a dielectric ceramic sheet, the first internal electrode pattern, and the second internal electrode pattern; forming a side margin portion on the side margin attachment surface; forming a body by sintering the stack chip on which the side margin portion is formed; and forming an external electrode on the body. The forming the side margin portion is performed by disposing a side margin sheet on the side margin attachment surface, and applying pressure thereto with a roller.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a perspective view schematically illustrating a multilayer electronic component according to an embodiment of the present disclosure.

FIG. 2 is a perspective view schematically illustrating a body according to an embodiment.

FIG. 3 is a view schematically perspective illustrating a stack chip according to an embodiment.

FIG. 4 is a cross-sectional view of FIG. 1, taken along line I-I′.

FIG. 5 is a cross-sectional view of FIG. 1, taken along line II-II′.

FIG. 6 is an exploded perspective view schematically illustrating an operation of forming a stack by stacking a dielectric ceramic sheet and an internal electrode pattern.

FIGS. 7A and 7B are perspective views schematically illustrating an operation of cutting a stack.

FIG. 8A is a perspective view schematically illustrating an operation of widening a gap between a plurality of stack chips, and FIG. 8B is a perspective view schematically illustrating an operation of opening a side margin attachment surface by rotating a plurality of stack chips.

FIG. 9A is a plan view schematically illustrating an operation of pressing a side margin sheet onto a conventional stack chip, and FIG. 9B is a plan view schematically illustrating an operation of punching a side margin sheet onto a conventional stack chip.

FIG. 10 is a schematic diagram schematically illustrating an example of an operation of forming a side margin portion in a method for manufacturing a multilayer electronic component according to an embodiment.

FIG. 11 is a plan view schematically illustrating S4 of FIG. 10.

FIG. 12 is a plan view schematically illustrating S5 of FIG. 10.

FIG. 13 is a graph illustrating a thickness of a multilayer electronic component (chip) after sintering according to Comparative Example and Inventive Example.

FIG. 14A is a graph illustrating results of a moisture resistance reliability test of a multilayer electronic component according to Comparative Example, and FIG. 14B is a graph illustrating results of a moisture resistance reliability test of a multilayer electronic component according to Inventive Example.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinarily skilled artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a first direction may mean a direction in which a dielectric ceramic sheet and an internal electrode pattern are stacked, or a direction in which a dielectric layer and an internal electrode are stacked, or a thickness direction of a multilayer electronic component.

In addition, in the drawings, a second direction may mean a direction, perpendicular to the first direction, or a length direction, and a third direction may mean a direction, perpendicular to the first direction and the second direction, or a width direction.

### Multilayer Electronic Component

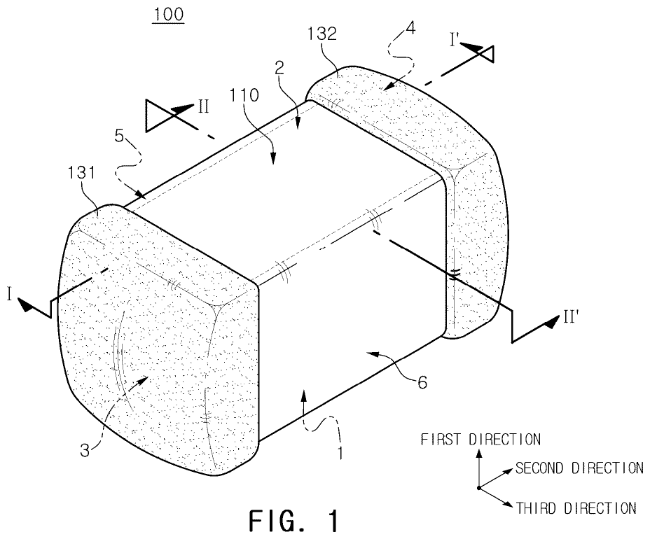

Hereinafter, before describing in detail a method for manufacturing a multilayer electronic component according to an embodiment of the present disclosure, a multilayer electronic component 100 according to an embodiment will be described in detail with reference to FIGS. 1 to 5.

FIG. 1 is a perspective view schematically illustrating a multilayer electronic component according to an embodiment of the present disclosure.

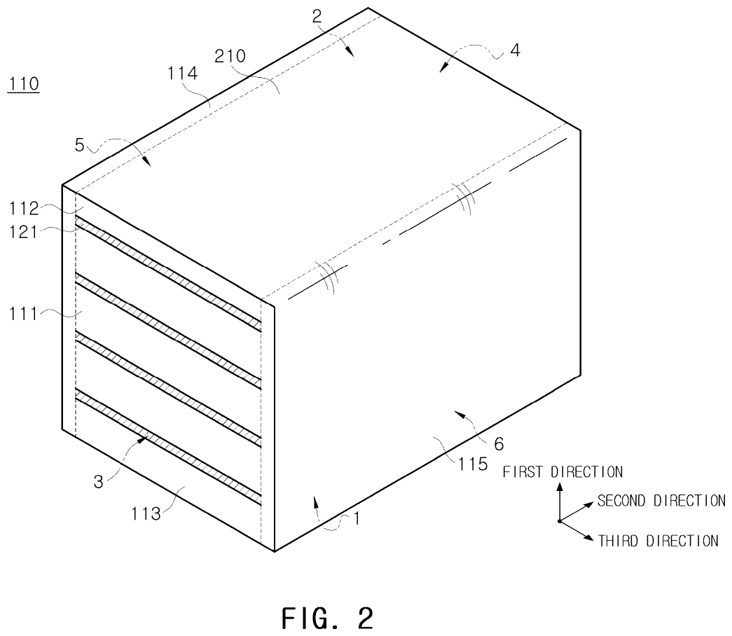

FIG. 2 is a perspective view schematically illustrating a body according to an embodiment.

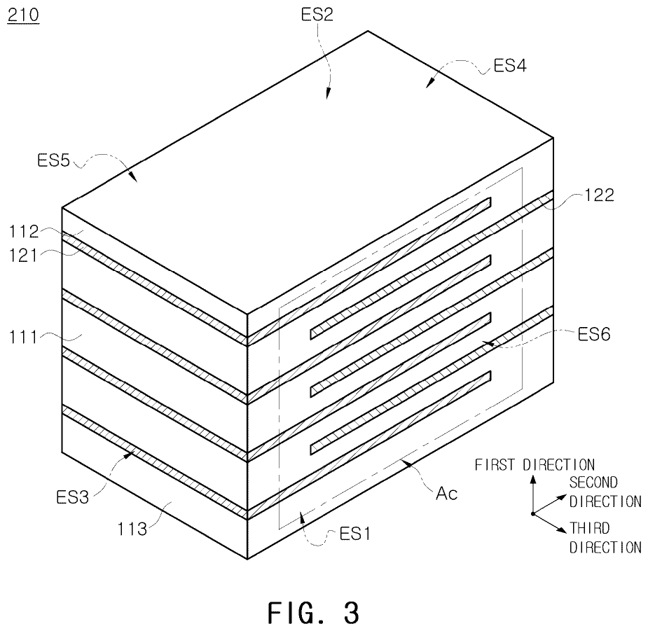

FIG. 3 is a perspective view schematically illustrating a stack chip according to an embodiment.

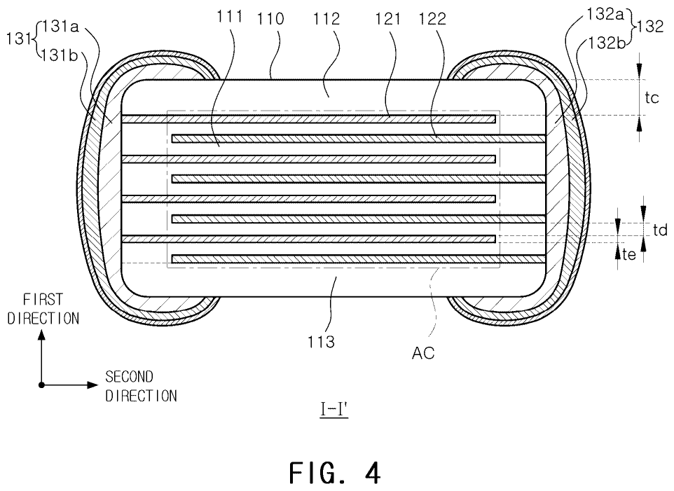

FIG. 4 is a cross-sectional view of FIG. 1, taken along line I-I′.

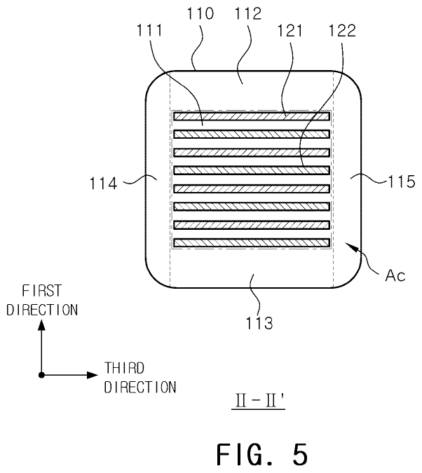

FIG. 5 is a cross-sectional view of FIG. 1, taken along line II-II′.

Referring to FIG. 1, a multilayer electronic component 100 according to an embodiment may include an external electrode 131/132 disposed on a body 110.

Referring to FIG. 2, the body 110 may include a stack chip 210 and a side margin portion 114/115 disposed on the stack chip 210. Although the specific shape of the body 110 is not particularly limited, the body 110 may have a hexahedral shape or the like, as illustrated in FIG. 2. Due to shrinkage of ceramic powder particles included in the body 110 during a sintering process, the body 110 may not have a perfectly straight hexahedral shape, but may have a substantially hexahedral shape.

Referring to FIG. 2, a body 110 may include one surface and the other surface 1 and 2 opposing in a first direction, one surface and the other surface 3 and 4 opposing in a second direction, and one surface and the other surface 5 and 6 opposing in a third direction. In this case, the first direction may be defined as a direction in which a plurality of dielectric layers 111 and a plurality of internal electrodes 121 and 122 are stacked, the second direction may be perpendicular to the first direction, and may mean a direction in which an end of a first internal electrode 121 and an end of a second internal electrode 122, among the plurality of internal electrodes 121 and 122, may be alternately exposed from a surface of the body 110, and the third direction may mean a direction, perpendicular to the first and second directions.

The body 110 may include a corner connecting one surface and the other surface opposing in the first direction to the third direction. The corner of the body may be formed by shrinkage behavior during the sintering process. In an embodiment, the corner of the body 110 may be rounded. Accordingly, chipping defects of a multilayer electronic component 100 may be suppressed.

Referring to FIG. 3, a stack chip 210 may include a dielectric layer 111 and an internal electrode 121/122. The dielectric layer 111 and the internal electrode 121/122 may be alternately disposed in the first direction, and the stack chip 210 may include a capacitance formation portion Ac which may be a region in which the dielectric layer 111 and the internal electrode 121/122 overlap in the first direction, and a cover portion 112/113 disposed on one surface and the other surface of the capacitance formation portion Ac in the first direction.

Referring to FIG. 3, the stack chip 210 may include a first side surface and a second side surface ES1 and ES2, opposing in the first direction, a third side surface and a fourth side surface ES3 and ES4, opposing in the second direction, and a fifth side surface and a sixth side surface ES5 and ES6, opposing in the third direction.

Each of the side surfaces of the stack chip 210 may form a surface of the body 110 after sintering or may be covered by a side margin portion 114/115. Specifically, the first side surface ES1 may form the first surface 1 of the body 110, the second side surface ES2 may form the second surface 2 of the body 110, the third side surface ES3 may form the third surface 3 of the body 110, and the fourth side surface ES4 may form the fourth surface 4 of the body 110. The fifth side surface ES5 and the sixth side surface ES6 may be respectively covered by the side margin portions 114 115 to be described later. In the present specification, for convenience of explanation, the fifth side surface ES5 and the sixth side surface ES6 may be defined as side margin portion attachment surfaces.

The dielectric layer 111 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. For example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃ (0<x21 1), Ba(Ti_{1-y}Ca_{y})O₃ (0<y<1), (Ba₁₋ₓCaₓ)(Ti_{1-y}Zr_{y})O₃ (0<x<1, 0<y<1), Ba (Ti_{1-y}Zr_{y})O₃ (0<y<1), or the like, in which calcium (Ca), zirconium (Zr), or the like is partially dissolved in BaTiO₃, or the like.

In addition, various ceramic additives, organic solvents, binders, dispersants, or the like may be added to the powder of barium titanate (BaTio₃), and the like, as the raw material for forming the dielectric layer 111.

An average thickness td of the dielectric layer 111 does not need to be particularly limited. In general, when the dielectric layer 111 is formed thinly with a thickness of less than 0.6 μm, especially when the average thickness td of the dielectric layer 111 is 0.35 μm or less, there may be a concern that reliability may be reduced.

According to an embodiment of the present disclosure, since an operation of forming a side margin portion is performed by disposing a side margin sheet on a side margin portion attachment surface and applying pressure thereto with a roller, even when the average thickness td of the dielectric layer 111 is 0.35 μm or less, excellent moisture resistance reliability of a multilayer electronic component 100 may be secured.

Therefore, when the average thickness td of the dielectric layer 111 is 0.35 μm or less, an effect according to the present disclosure may be more remarkable, and miniaturization and high capacitance of the multilayer electronic component 100 may be more easily achieved.

The average thickness td of the dielectric layer 111 may mean an average size of the dielectric layer 111 disposed between first and second internal electrodes 121 and 122 in the first direction. When the body 110 includes a plurality of dielectric layers 111, the average thickness td of the dielectric layer 111 may mean an average thickness of at least one of the plurality of dielectric layers 111.

The average thickness td of the dielectric layer 111 may be measured by scanning an image of a cross-section of the body 110 in the length and thickness directions (L-T) with a scanning electron n microscope (SEM) at 10,000× magnification. More specifically, a thickness of one dielectric layer may be measured at 30 points equally spaced in the length direction in the scanned image to measure an average value. The 30 equally spaced points may be designated in the capacitance formation portion Ac. In addition, when measurement of the average value is extended to 10 dielectric layers and average values thereof are measured, the average thickness of the dielectric layer may be further generalized.

The cover portions (112 and 113) may be respectively disposed on one surface and the other surface of the capacitance formation portion Ac in the first direction. The cover portions 112 and 113 may be formed by stacking a single dielectric layer or two or more dielectric layers on one surface and the other surface of the capacitance formation portion Ac, respectively, in the first direction, and may basically play a role of preventing damage to the internal electrode due to physical or chemical stress.

The cover portions 112 and 113 does not include an internal electrode, and may include substantially the same material as the dielectric layer 111.

An average thickness tc of the cover portion 112/113 does not need to be particularly limited. To more easily achieve miniaturization and high capacitance of the multilayer electronic component, the average thickness tc of the cover portion 112/113 may be 15 μm or less. In this case, the average thickness of the cover portion 112/113 may mean an average thickness of a first cover portion 112 and an average thickness of a second cover portion 113, respectively.

The average thickness tc of the cover portion 112/113 may mean a first direction size, and may be an average value of the first direction size of the cover portion 112/113 measured at five equally spaced points above or below the capacitance formation portion Ac.

The internal electrodes 121 and 122 may be alternately disposed with the dielectric layer 111 in the first direction, and the internal electrodes 121 and 122 may include first and second internal electrodes 121 and 122. Referring to FIGS. 2 and 3, the first and second internal electrodes 121 and 122 may be alternately disposed to face each other with the dielectric layer 111 interposed therebetween, and may be connected to one or more of the third to sixth side surfaces ES3, ES4, ES5, and ES6 of the stack chip 210.

Specifically, one end of the first internal electrode 121 in the second direction may be connected to the third side surface ES3, the other end of the first internal electrode 121 in the second direction may be spaced from the fourth side surface ES4, and one end of the second internal electrode 122 in the second direction may be connected to the fourth side surface ES4, and the other end of the second internal electrode 122 in the second direction may be spaced from the third side surface ES3.

For example, the first internal electrode 121 may not be connected to a second external electrode 132 but may be connected to a first external electrode 131, and the second internal electrode 122 may not be connected to the first external electrode 131 but may be connected to the second external electrode 132. In this case, the first and second internal electrodes 121 and 122 may be electrically separated from each other by a dielectric layer 111 disposed in an intermediate portion.

Referring to FIG. 2, both ends of the first internal electrode 121 in the third direction and both ends of the second internal electrode 122 in the third direction may be simultaneously connected to the fifth side surface ES5 and the sixth side surface ES6. Therefore, a proportion of the capacitance formation portion Ac in the entire component may increase, thereby maximizing capacitance per unit volume of the multilayer electronic component 100, and a step difference according to a stacking degree of the internal electrode of the side margin portion 114/115 and the capacitance formation portion Ac may be alleviated.

A material forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including one or more of nickel (Ni), copper (Cu), palladium (Pd), silver (Ag), gold (Au), platinum (Pt), tin (Sn), tungsten (W), titanium (Ti), and alloys thereof on a ceramic green sheet. A method of printing the conductive paste for internal electrodes may use a screen printing method, a gravure printing method, or the like, and the present disclosure is not limited thereto.

An average thickness the of the internal electrode 121/122 does not need to be specifically limited.

In general, when the internal electrode 121/122 is formed thinly with a thickness of less than 0.6 μm, especially when the average thickness the of the internal electrode 121/122 is 0.35 μm or less, there may be a concern that reliability may be reduced.

According to an embodiment of the present disclosure, since the operation of forming a side margin portion is performed by disposing a side margin sheet on a side margin portion attachment surface and applying pressure thereto with a roller, even when the average thickness the of the internal electrode 121/122 is 0.35 μm or less, excellent moisture resistance reliability of the multilayer electronic component 100 may be secured.

Therefore, when the average thickness the of the internal electrode 121/122 is 0.35 μm or less, an effect according to the present disclosure may be more remarkable, and miniaturization and high capacitance of the multilayer electronic component 100 may be more easily achieved.

The average thickness the of the internal electrode 121/122 may mean an average size of the internal electrode 121/122 in the first direction. When the body 110 includes a plurality of internal electrodes 121 and 122, the average thickness the of the internal electrode 121/122 may mean an average thickness of at least one of the plurality of internal electrodes 121 and 122.

The average thickness the of the internal electrode 121/122 may be measured by scanning an image of a cross-section of the body 110 in the length and thickness directions L-T with a scanning electron microscope (SEM) at 10,000× magnification. More specifically, a thickness of one internal electrode may be measured at 30 equally spaced points in the length direction in the scanned image to measure an average value. The 30 equally spaced points may be designated in the capacitance formation portion Ac. In addition, when measurement of the average value is extended to 10 internal electrodes and average values thereof are measured, the average thickness of the internal electrode may be further generalized.

Referring to FIGS. 1, 2, and 5, the side margin portions 114 and 115 may be respectively disposed on the fifth and sixth side surfaces ES5 and ES6 of the stack chip 210.

The side margin portions 114 and 115 may basically play a role in preventing damage to the internal electrodes due to physical or chemical stress.

A material forming the side margin portions 114 and 115 does not need to be particularly limited, and may be formed of the same material as the dielectric layer 111, but is not limited thereto, and may have a different composition as a result of being formed of a different material from the dielectric layer 111.

A width of the side margin portion 114/115 does not need to be particularly limited. To more easily achieve miniaturization and high capacitance of the multilayer electronic component, an average width of the side margin portion 114/115 may be 15 μm or less.

The average width of the side margin portion 114/115 may mean an average size of the side margin portion 114/115 in the third direction, and may be an average value of sizes of the side margin portion 114/115 in the third direction measured at five equally spaced points on a side surface of the capacitance formation portion Ac.

The external electrode 131/132 may be disposed on the third surface or the fourth surface of the body 110. Specifically, a first external electrode 131 may be disposed on one surface 3 of the body 110 in the second direction, and may be connected to the first internal electrode 121, and a second external electrode 132 may be disposed on the other surface 4 of the body 110 in the second direction, and may be connected to the second internal electrode 122.

In the present embodiment, although a structure in which the multilayer electronic component 100 has two external electrodes 131 and 132 is illustrated, the number or shapes of the external electrodes 131 and 132 may be changed depending on a shape of the internal electrodes 121 and 122 or other purposes.

The external electrodes 131 and 132 may be formed using any material having electrical conductivity, such as metal or the like, and a specific material may be determined by considering electrical characteristics, structural stability, or the like, and further, may have a multilayer structure.

The external electrodes 131 and 132 may be respectively formed on one surface and the other surface of the body 110 in the second direction, but may be disposed to extend onto a portion of one surface and the other surface of the body 110 in the first direction or one surface and the other surface of the body 110 in the third direction. In this case, the external electrode 131/132 may be disposed to cover an end of the side margin portion 114/115. In this case, a region of the external electrode 131/132 disposed on the end of the side margin portion 114/115 may have a round shape, and thus, coverage of the external electrode 131/132 may be secured even on a corner of the body 110 or the side margin portion 114/115.

The external electrode 131/132 may include an electrode layer 131a/132a disposed on the body 110 and a plating layer 131b/132b formed on the electrode layer 131a/132a.

For a more specific example of the electrode layer 131a/132a, the electrode layer may be a sintered electrode including a conductive metal and glass, or a resin-based electrode including a conductive metal and a resin.

In addition, the electrode layer 131a/132a may be formed in a form in which a sintered electrode and a resin-based electrode are sequentially formed on the body 110. In addition, the electrode layer 131a/132a may be formed by transferring a sheet including a conductive metal onto the body 110, or may be formed by transferring a sheet including a conductive metal onto the sintered electrode.

A material having excellent electrical conductivity may be used as the conductive metal included in the electrode layer 131a/132a, and is not particularly limited. For example, the conductive metal may be one or more of nickel (Ni), copper (Cu), and alloys thereof.

The plating layer 131b/132b may play a role in improving sealing or mounting characteristics of the multilayer electronic component 100. A type of the plating layer 131b/132b is not particularly limited, and may be a plating layer including one or more of Ni, Sn, Pd, and alloys thereof, and may be formed as a plurality of layers.

For a more specific example of the plating layer 131b/132b, the plating layer 131b/132b may be a plating layer including Ni or a plating layer including Sn, and may be in a form in which a plating layer including Ni and a plating layer including Sn are sequentially formed on the electrode layer 131a/132a, or may be in a form in which a plating layer including Sn, a plating layer including Ni, and a plating layer including Sn are sequentially formed. In addition, the plating layer may include a plurality of Ni plating layers and/or a plurality of Sn plating layers.

### Method for Manufacturing Multilayer Electronic Component

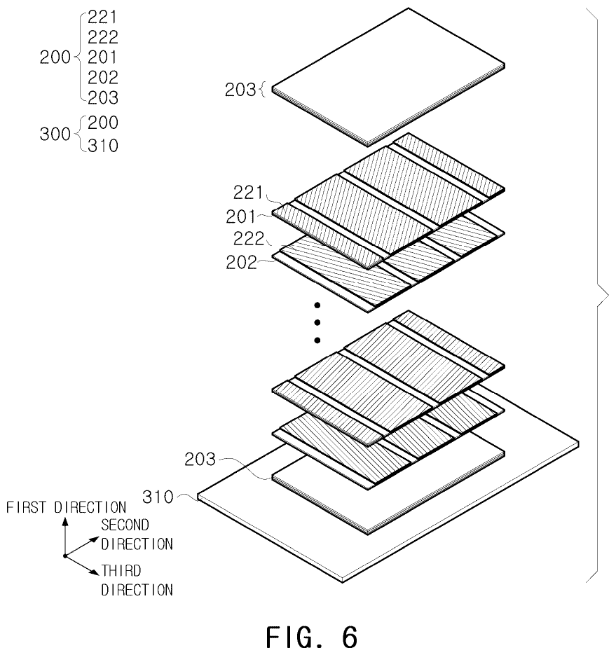

Hereinafter, a method for manufacturing a multilayer electronic component will be described in detail with reference to FIGS. 6 to 12. A method for manufacturing a multilayer electronic component according to an embodiment of the present disclosure is not limited to the method for manufacturing the multilayer electronic component 100 described above.

FIG. 6 is an exploded perspective view schematically illustrating an operation of forming a stack by stacking a dielectric ceramic sheet and an internal electrode pattern.

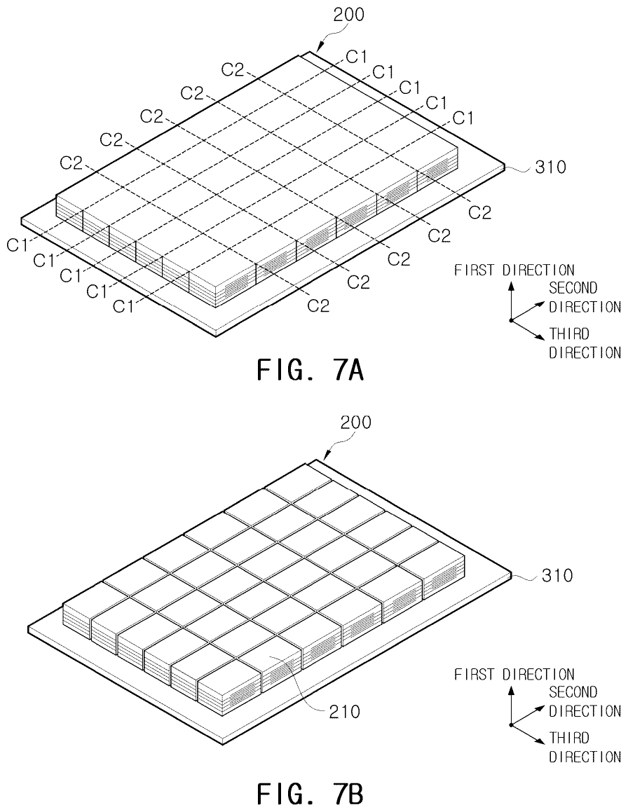

FIGS. 7A and 7B are perspective views schematically illustrating an operation of cutting a stack.

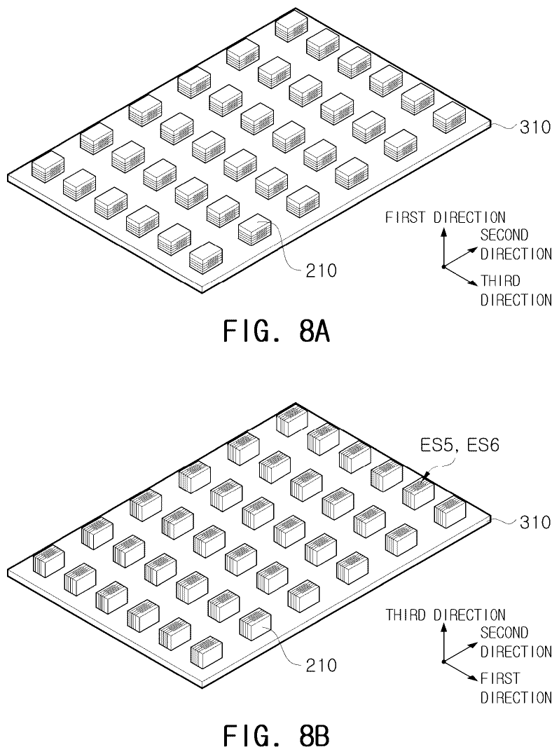

FIG. 8A is a perspective view schematically illustrating an operation of widening a gap between a plurality of stack chips, and FIG. 8B is a perspective view schematically illustrating an operation of opening a side margin attachment surface by rotating a plurality of stack chips.

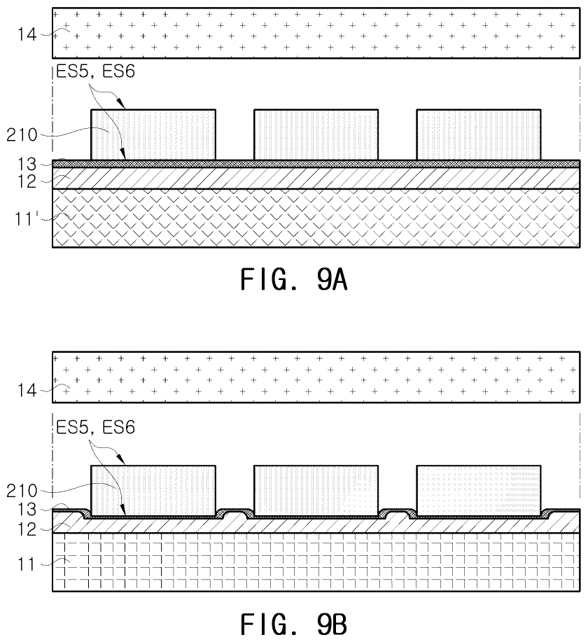

FIG. 9A is a plan view schematically illustrating an operation of pressing a side margin sheet onto a conventional stack chip, and FIG. 9B is a plan view schematically illustrating an operation of punching a side margin sheet onto a conventional stack chip.

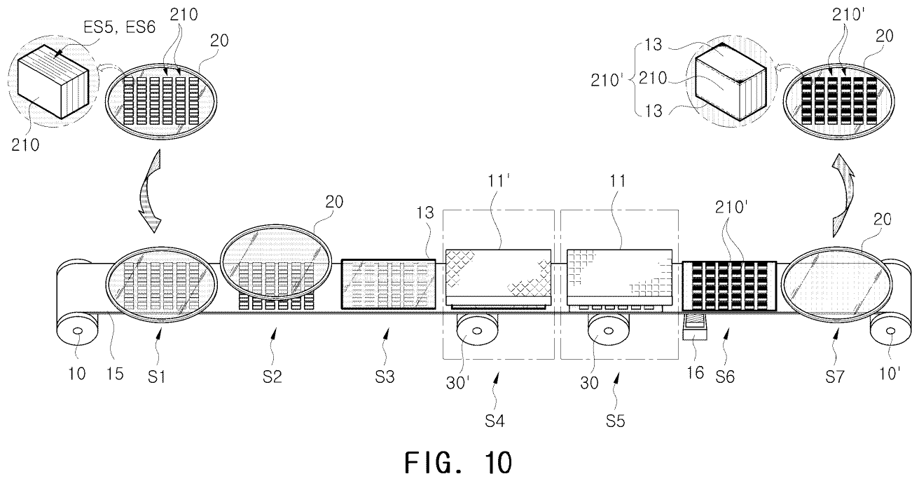

FIG. 10 is a schematic diagram schematically illustrating an example of an operation of forming a side margin portion in a method for manufacturing a multilayer electronic component according to an embodiment.

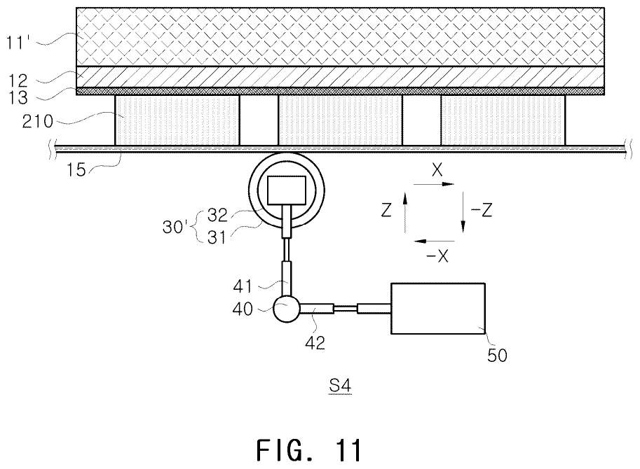

FIG. 11 is a plan view schematically illustrating S4 of FIG. 10.

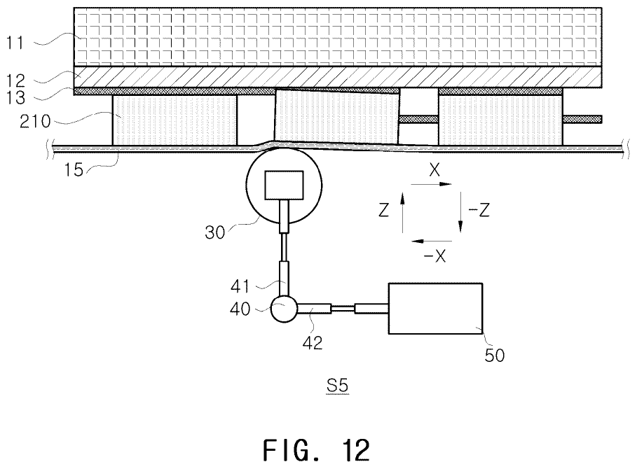

FIG. 12 is a plan view schematically illustrating S5 of FIG. 10.

A method for manufacturing a multilayer electronic component according to an embodiment of the present disclosure may include an operation of forming a stack chip 210 including a side margin attachment surface ES5/ES6 connected to a first internal electrode pattern 221 and a second internal electrode pattern 222 by alternately disposing a dielectric ceramic sheet 201/202, the first internal electrode pattern 221, and the second internal electrode pattern 222; an operation of forming a side margin portion 114/115 on the side margin attachment surface; and an operation of sintering the stack chip on which the side margin portion is formed. The operation of forming a side margin portion may be performed by disposing a side margin sheet 13 on the side margin attachment surface, and applying pressure thereto with a roller 30/30′.

Referring to FIG. 6, a method for manufacturing a multilayer electronic component according to an embodiment of the present disclosure may include an operation of forming a stack body 200 by alternately disposing a dielectric ceramic sheet 201/202/203, a first internal electrode pattern 221, and a second internal electrode pattern 222.

The operation of forming a stack body 200 may be performed by alternately disposing a dielectric ceramic sheet 201/202, the first internal electrode pattern 221, and the second internal electrode pattern 222 on a support film 310, and the dielectric ceramic sheet 201/202 may be disposed between the first internal electrode pattern 221 and the second internal electrode pattern 222. An internal electrode pattern disposed on an uppermost end and an internal electrode pattern disposed on a lowermost end may be covered by a dielectric ceramic sheet 203, and in this case, the dielectric ceramic sheet 203 may form a cover portion 112/113 in the multilayer electronic component 100.

The dielectric ceramic sheet 201/202/203 may be manufactured by preparing a slurry in which dielectric main component powder particles such as barium titanate (BaTiO₃) or the like are mixed with an additive, an organic solvent, a binder, a dispersant, or the like, and forming the slurry to have a sheet shape.

Among the dielectric ceramic sheets, the dielectric ceramic sheet 201/202 disposed between the first and second internal electrode patterns 221 and 222 may form a dielectric layer 111 of the multilayer electronic component 100 after sintering.

The internal electrode pattern 221/222 may have a stripe shape. Specifically, the internal electrode pattern may be formed to contact both ends of the dielectric ceramic sheet 201/202 in the third direction, at a constant interval in the second direction.

The internal electrode pattern 221/222 may include a conductive metal such as one or more of nickel (Ni), copper (Cu), palladium (Pd), silver (Ag), gold (Au), platinum (Pt), tin (Sn), tungsten (W), titanium (Ti), and alloys thereof, and may be printed on the dielectric ceramic sheet 201/202. A method of printing the internal electrode pattern 221/222 may use a screen printing method, a gravure printing method, or the like, and the present disclosure is not limited thereto.

The operation of forming a stack body 200 may be performed by stacking the internal electrode patterns 221 and 222 and the dielectric ceramic sheets 201, 202, and 203 on the support film 310 and pressing them together.

Referring to FIG. 7A and FIG. 7B, a stack body 200 may be cut along cutting lines C1-C1 and C2-C2, orthogonal to each other. The cutting line C1-C1 may be a cutting line, parallel to the second direction, and may be disposed at substantially equal intervals in the third direction, and the cutting line C2-C2 may be a cutting line, parallel to the third direction, and may be disposed at substantially equal intervals in the second direction. A stack chip 210 having a substantially constant third direction size may be formed by the cutting line C1-C1, and a stack chip 210 having a substantially constant second direction size may be formed by the cutting line C2-C2.

A means for cutting the stack body 200 is not particularly limited. For example, the stack body 200 may be cut using a blade cutting method such as a doctor blade, a dicing blade, or the like, a guillotine cutting method, or a laser cutting method.

Referring to FIG. 8A, after cutting a stack body 200 to form stack chips 210, an operation of increasing a distance between the plurality of stack chips 210 may be performed. The operation may be performed by increasing a support film 310 in the second direction and the third direction, but is not limited thereto, and may also be performed by moving the plurality of stack chips 210 to a separate support film.

Referring to FIG. 8B, an operation of opening a side margin attachment surface ES5/ES6 of a stack chip 210 may be performed. The operation may be a process of simultaneously opening a fifth side surface ES5 or a sixth side surface ES6, which may be a surface on which side margins of a plurality of stack chips 210 are to be formed, to easily form a side margin portion. As described in the multilayer electronic component 100 according to an embodiment, the side margin attachment surface of the stack chip 210 may be a surface to which both ends of a first internal electrode pattern 221 and both ends of a second internal electrode pattern 222 are connected.

The operation of opening a side margin attachment surface ES5/ES6 of a stack chip 210 is not particularly limited. For example, the operation may be performed by simultaneously rotating the plurality of unit chips 210 or moving them to a different film without rotation.

Referring to FIG. 9A and FIG. 9B, an operation of forming a conventional side margin portion may be performed by disposing a side margin sheet 13, an elastic plate 12, and a pressure plate 11/11′ on one surface of a side margin attachment surface ES5/ES6 of a stack chip 210, disposing a metal plate 14 on a surface, opposite thereto, and then applying pressure to a pressure plate 11/11′ and the metal plate 14, to perform a pressing process and a punching process. An operation of forming a side margin portion in a manner with which surfaces are in contact (plate-to-plate) may increase adhesion distribution between the stack chip 210 and the side margin sheet 13, depending on thermal expansion distribution of the metal plate 14 and the pressure plate 11/11′ and an angle formed by the metal plate 14 and the pressure plate 11/11′, and therefore, moisture resistance reliability of the multilayer electronic component may be reduced.

Referring to FIGS. 10 to 12, an operation of forming a side margin portion in a method for manufacturing a multilayer electronic component according to an embodiment of the present disclosure may be performed by disposing a side margin sheet 13 on a side margin attachment surface ES5/ES6, and applying pressure thereto with a roller 30/30′.

Therefore, instead of a stack chip 210 and a side margin sheet 13 being pressed and punched by pressure generated when surfaces meets, the stack chip 210 and the side margin sheet 13 may be pressed and punched by the pressure generated when a surface meets a line, thereby minimizing and uniformizing spatial distribution of components involved in the operation of forming a side margin portion, and therefore, deformation of the stack chip 210 may be reduced by pressing and punching the stack chip 210 and the side margin sheet 13, and adhesion between the stack chip 210 and the side margin sheet 13 may be improved.

Depending on a length of the roller 30/30′, the roller 30/30′ may apply pressure to multiple stack chips 210 at the same time. For example, the operation of forming the side margin portion according to an embodiment may be performed simultaneously on a plurality of arrayed stack chips 210.

Referring to FIG. 10, in the operation of forming a side margin portion according to an embodiment, a carrier film 15 connected to a transfer roll 10 and a recovery roll 10′ may be disposed, and the stack chip 210 may be attached to the carrier film 15.

In this case, the carrier film 15 may lose or improve adhesive function thereof due to irradiation with an ultraviolet light or the like, and therefore, after performing the operation of forming a side margin portion once, the same process may be repeated on a different side margin portion attachment surface to which the side margin sheet is not attached.

Components of the carrier film 15 are not particularly limited. In an embodiment, the carrier film 15 may include one or more of polyethylene terephthalate (PET), polyurethane (PU), polyethylene (PE), polyolefin (PO), Polystyrene (PS), polyvinyl chloride (PVC), and Polyvinylidene chloride (PVDC).

Referring to FIG. 10, the operation of forming a side margin portion according to an embodiment may be performed by disposing a plurality of stack chips 210 on one surface of the carrier film 15, and therefore, the roller 30/30′ may directly apply pressure to a surface of the carrier film 15 to which the stack chips 210 are not attached.

In an embodiment, the operation of forming a side margin portion may include a pressing operation S4 of pressing the side margin sheet 13 to the side margin portion attachment surface ES5/ES6 by pressing with a pressing roller 30′, and a punching operation S5 of punching the side margin sheet 13 attached to the side margin portion attachment surface ES5/ES6 by using a punching roller 30.

The operation of forming a side margin portion according to an embodiment may include S1 to S7 as illustrated in FIG. 10. For convenience of explanation, the pressing operation S4 and the punching operation S5 will be described in detail below, and then remaining operations will be described.

### S4

In an embodiment, the pressing operation S4 may be performed by disposing an elastic plate 12 and a metal plate 11′ on the side margin sheet 13.

In an embodiment, the metal plate 11′ in the pressing operation S4 may be heated to a temperature, higher than room temperature, specifically, may be heated to a temperature of 50° C. to 150° C. Therefore, fluidity of the elastic plate 12 and fluidity of the side margin sheet 13 may be improved, thereby alleviating warping of the plurality of stack chips 210.

In an embodiment, the pressing roller 30′ used in the pressing operation S4 may include a high-rigidity portion 31 disposed in a central portion, and a low-rigidity portion 32 disposed on the high-rigidity portion 31. The high-rigidity portion 31 may play a role of maintaining rigidity of the pressing roller 30′, and the low-rigidity portion 32 may play a role of reducing pressure distribution according to a position applied to each of the plurality of stack chips 210 in the pressing operation S4.

A material included in the high-rigidity portion 31 is not particularly limited, and a material with high rigidity and durability may be used. A material included in the low-rigidity portion 32 is not particularly limited, and may be, for example, polyurethane.

### S5

In an embodiment, the punching operation S5 may be performed by disposing an elastic plate 12 and a metal plate 11 on the side margin sheet 13.

In an embodiment, the metal plate 11 in the punching operation S5 may be maintained at 50° C. or lower or at room temperature or a temperature, lower than room temperature, to prevent thermal shock. For example, the punching operation S5 may be performed without heating the metal plate 11. Therefore, when fluidity of the side margin sheet 13 is reduced to apply pressure, a region of the side margin sheet 13, other than a region corresponding to the side margin attachment surface ES5/ES6, may be cut.

In an embodiment, the punching roller 30 used in the punching operation S5 may be formed as the high-rigidity portion. Therefore, pressure applied in the punching operation S5 may be effectively transmitted to the side margin sheet 13.

In addition to the operation of disposing a side margin sheet 13 on a side margin attachment surface ES5/ES6, and the operation of applying pressure thereto with a roller 30/30′, additional processes S1 to S3, S6, and S7 may also be performed before or after the operation of forming a side margin portion according to an embodiment.

Hereinafter, S1 to S3, S6, and S7 will be described in detail.

### S1

To perform the operation of forming a side margin portion, a plurality of stack chips 210 may move through an adhesive member 20. The adhesive member 20 may have a form in which an adhesive film is fixed with a ring.

The adhesive member 20 may rotate such that the plurality of stack chips 210 face a carrier film 15, and may move such that the plurality of stack chips 210 are attached to the carrier film 15.

### S2

After the plurality of stack chips 210 are attached to the carrier film 15, the adhesive member 20 may be separated from the plurality of stack chips 210. This separation may be achieved by adjusting adhesion between the plurality of stack chips 210 and the carrier film 15 to be greater than adhesion between the plurality of stack chips 210 and the adhesive member 20.

A method of adjusting adhesion between the carrier film 15 and the stack chip 210 is not particularly limited. As an example, a method of increasing or decreasing adhesion of the carrier film 15, depending on a wavelength of ultraviolet light, may be used.

### S3

After S2, a side margin sheet 13 may be disposed on a side margin attachment surface of the stack chip 210. In this case, since the side margin sheet 13 has not yet undergone a pressing operation S4 or a punching operation S5, adhesion between the side margin sheet 13 and the stack chip 210 may be minimal. To further enhance adhesion between the stack chip 210 and the side margin sheet 13, a separate adhesive layer may be additionally disposed between the stack chip 210 and the side margin sheet 13.

### S6

After the punching operation S5, an operation of separating a stack chip 210′ to which the side margin sheet 13 is attached from the carrier film 15 may be performed. A method of separating the stack chip 210′ to which the side margin sheet 13 is attached, from the carrier film 15, is not particularly limited, and for example, a method of disposing an ultraviolet irradiation unit 16 below the carrier film 15, and irradiating the carrier film 15 with ultraviolet light, to reduce or lose adhesion between the stack chip 210′ and the carrier film 15, may be used.

### S7

After S6, a process of separating the stack chip 210′ to which the side margin sheet 13 is attached, from the carrier film 15, using the adhesive member 20, may be performed. Since adhesion between the carrier film 15 and the stack chip 210′ to which the side margin sheet 13 is attached may be reduced or lost through S6, the stack chip 210′ may be attached to the adhesive member 20, and may be separated from the carrier film 15.

Since the operation of forming a side margin portion according to an embodiment illustrated in FIG. 10 is to attach the side margin sheet to one of the side margin portion attachment surfaces ES5 and ES6 of the stack chip 210, S1 to S7 may be performed on one of the side margin portion attachment surfaces ES5 and ES6, and then the same S1 to S7 may be performed on the other side margin portion attachment surface to which the side margin sheet 13 is not attached, such that the side margin sheet 13 may be attached to all of the side margin portion attachment surfaces ES5 and ES6.

Afterwards, an operation of forming a body by sintering the stack chip 210′ to which the side margin sheet 13 is attached may be included. A sintering temperature is not particularly limited, but may be sintered at, for example, 1000 to 1300° C. In addition, the sintering may be performed under a reducing atmosphere.

Afterwards, external electrodes 131 and 132 may be respectively formed on one surface and the other surface of a body 110 in the second direction, thereby manufacturing a multilayer electronic component 100. The external electrodes 131 and 132 may be formed by disposing a conductive paste containing a metal having excellent electrical conductivity, respectively, on the second direction one surface and the other surface 3 and 4 in the second direction, and sintering them simultaneously with the body 110.

Referring to FIGS. 11 and 12, a roller 30/30′ may move in an X-direction, which may be a transport direction of the carrier film 15 or the stack chip 210, and in a-X direction, which may be a direction, opposite thereto, and may move in a Z-direction, which may be a direction in which the side margin sheet 13, the elastic plate 12, and the metal plate 11 are stacked, and perpendicular to the X-direction, and in a-Z-direction, which may be a direction, opposite thereto. The pressure in the pressing operation and the punching operation may move in the Z-direction facing the side margin sheet, and may be applied by the roller 30 and 30′.

In an embodiment, the roller 30/30′ may be connected to a driver for driving the roller 30/30′. In this case, the driver may include a servo motor 40, a vertical movement rod 41 connected to the servo motor 40, and a horizontal movement rod 42.

In an embodiment, the roller 30/30′ may move in one or more axes of the X-axis direction and the Z-axis direction according to movement of the driver. In this case, Z-axis movement displacement of the roller 30/30′ may be determined according to a relative position between the stack chip 210 and the roller 30/30′, and an X-axis movement speed may be determined according to a process time required.

In an embodiment, the vertical movement rod 41 and the horizontal movement rod 42 may be formed as pneumatic cylinders, but are not limited thereto, and the servo motor may be connected to a fixed support 50 of the driver.

### Experimental Example 1

Table 1 below shows average values (avg), standard deviations (std), and coefficients of variation (Cv) of thicknesses (T) and widths (W) of a body after sintering, when an operation of forming a side margin portion according to a conventional technique (Comparative Example) and an operation of forming a side margin portion according to an embodiment of the present disclosure (Inventive Examples 1, 2, and 3) were performed in an initial stack chip state in which an average value of thicknesses was 455 μm and an average value of widths was 450 μm.

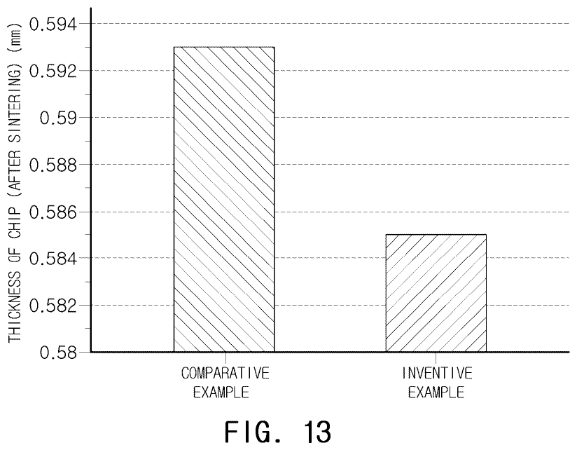

FIG. 13 is a graph illustrating thicknesses of bodies according to Comparative Example and Inventive Example, and in the Inventive Example, an average value of values measured in Inventive Examples 1 to 3.

An average value of thicknesses and an average value of widths of stack chips and bodies were measured by measuring an average value of maximum thicknesses and an average value of maximum widths in the stack chips and the bodies, respectively.

Approximately 100,000 samples were produced for Comparative Example and Inventive Examples, respectively, and experimental conditions of the Comparative Example and Inventive Examples 1 to 3 were the same, except that, in the Comparative Example, pressing and punching were performed using a pressing plate and a metal plate, and in Inventive Examples 1 to 3, pressing and punching were performed using a metal plate and a pressing roller.

TABLE 1

| | Examples | | | |
|---|---|---|---|---|
| | Comparative | Inventive | Inventive | Inventive |
| | Ex. | Ex. 1 | Ex. 2 | Ex. 3 |
| T_avg(μm) | 476 | 463 | 467 | 463 |
| T_std(μm) | 8.66 | 4.64 | 5.21 | 7.10 |
| T_Cv | 1.82% | 1.00% | 1.12% | 1.53% |
| W_avg(μm) | 427 | 448 | 446 | 447 |
| W_std(μm) | 11.78 | 2.09 | 2.44 | 4.83 |
| W_Cv | 2.76% | 0.47% | 0.55% | 1.08% |

Referring to Table 1, it can be confirmed that Inventive Examples 1, 2, and 3 have a smaller T_avg value than the Comparative Example, and a greater W_avg value than the Comparative Example. Since pressure was applied in a width direction of stack chips during an operation of forming a side margin portion, it can be confirmed that Inventive Examples 1, 2, and 3 having a smaller T_avg value than the Comparative Example, and a greater W_avg value than the Comparative Example, have a smaller change in size than the Comparative Example.

Since Inventive Examples 1, 2, and 3 have T_std, T_Cv, W_std, and W_Cv values, lower than the Comparative Example, it can be confirmed that Examples 1, 2, and 3 have a smaller size dispersion of the chip, after sintering, than the Comparative Example.

Therefore, an operation of forming a side margin portion in a method for manufacturing a multilayer electronic component according to an embodiment of the present disclosure may be performed by disposing a side margin sheet 13 on a side margin attachment surface ES5/ES6, and applying pressure thereto with a roller 30/30′, thereby providing a multilayer electronic component having a decrease in size dispersion, as compared to a conventional case.

### Experimental Example 2

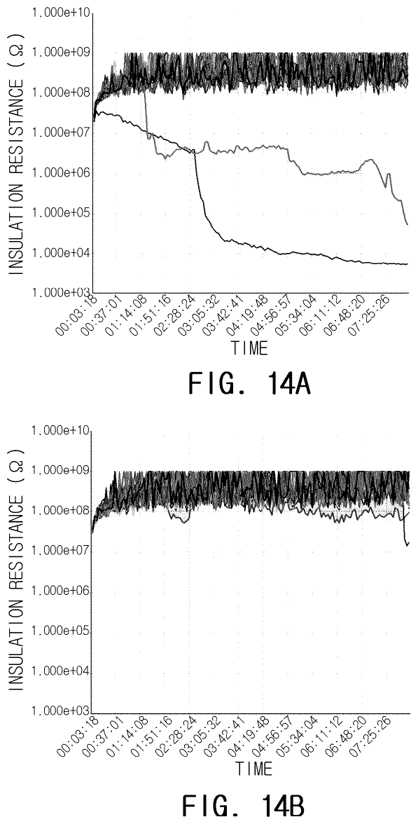

FIGS. 14A and 14B are graphs illustrating results of performing a composite reliability evaluation of multilayer electronic components according to Comparative Example and Inventive Example.

An operation of forming a side margin portion according to a conventional case (Comparative Example), and an operation of forming a side margin portion according to an embodiment of the present disclosure (Inventive Examples 1, 2, and 3) were performed, and then, after sintering, samples were produced by forming external electrodes. Experimental conditions of the Comparative Example and Inventive Examples 1 to 3 were the same, except that, in the Comparative Example, pressing and punching were performed using a pressing plate and a metal plate, and in Inventive Examples 1 to 3, pressing and punching were performed using a pressing plate and a roller.

The Comparative Example and the Inventive Example were conducted on 400 samples each, and insulation resistance (IR) was measured under evaluation conditions of 85% relative humidity, 85° C., 4.8 vr, and 4 hr. When insulation resistance values decreased to 10\hat{ }4 (2) or less, it can be considered as a reliability failure.

Referring to FIG. 14A, it can be confirmed that a failure occurred in the multilayer electronic component according to the Comparative Example, and referring to FIG. 14B, it can be confirmed that moisture-resistant reliability is excellent because no failure occurred.

Therefore, it can be confirmed that an operation of forming a side margin portion in a method for manufacturing a multilayer electronic component according to an embodiment of the present disclosure may be performed by disposing a side margin sheet 13 on a side margin attachment surface ES5/ES6, and applying pressure thereto with a roller 30/30′, thereby improving moisture-resistant reliability, as compared to a conventional case.

One of various effects of the present disclosure is to dispose a side margin sheet on a side margin attachment surface of a stack chip and applying pressure thereto with a roller to form a side margin portion, to improve moisture resistance reliability of a multilayer electronic component.

A number of effects of the present disclosure are to dispose a side margin sheet on a side margin attachment surface of a stack chip and applying pressure thereto with a roller to form a side margin portion, to reduce size dispersion of a multilayer electronic component.

Various advantages and effects of the present disclosure are not limited to the above-described contents, and will be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A method for manufacturing a multilayer electronic component, comprising:
forming a stack chip including a side margin attachment surface, connected to a first internal electrode pattern and a second internal electrode pattern, by alternately disposing a dielectric ceramic sheet, the first internal electrode pattern, and the second internal electrode pattern;
forming a side margin portion on the side margin attachment surface;
forming a body by sintering the stack chip on which the side margin portion is formed; and
forming an external electrode on the body,
wherein the forming the side margin portion is performed by disposing a side margin sheet on the side margin attachment surface, and applying pressure thereto with a roller.

2. The method of claim 1, wherein the forming the side margin portion includes a pressing operation of pressing the side margin sheet with a pressing roller to attach the side margin sheet to the side margin attachment surface, and a punching operation of punching the side margin sheet with a punching roller.

3. The method of claim 2, wherein the pressing operation is performed by disposing an elastic plate and a metal plate on the side margin sheet.

4. The method of claim 3, wherein the pressing operation is performed by heating the metal plate.

5. The method of claim 4, wherein the pressing operation is performed by heating the metal plate at a temperature of 50° C. to 150° C.

6. The method of claim 2, wherein the punching operation is performed by disposing an elastic plate and a metal plate on a green sheet for the side margin portion.

7. The method of claim 6, wherein the punching operation is performed without heating the metal plate.

8. The method of claim 2, wherein the pressing roller includes a high-rigidity portion and a low-rigidity portion having rigidity lower than the high-rigidity portion and disposed on the high-rigidity portion.

9. The method of claim 2, wherein the punching roller includes a high-rigidity portion.

10. The method of claim 1, wherein the stack chip is one among an array of stack chips, and
the forming the side margin portion is performed simultaneously on a row of the array of stack chips.

11. The method of claim 1, wherein the stack chip is one among an array of stack chips attached to a carrier film, and
the forming the side margin portion is performed by applying pressure to a surface of the carrier film to which the array of stack chips are not attached, by the roller.

12. The method of claim 1, wherein the forming the side margin portion is performed by the roller connected to a driver and moving toward the side margin sheet.

13. The method of claim 12, wherein the driver includes a servo motor, a vertical moving rod, and a horizontal moving rod.
